(19) United States
(12) Patent Application Publication
(10) Pub. No.: US 2024/0412097 A1
(43) Pub. Date: Dec. 12, 2024

(54) MULTI-MODAL REPRESENTATION LEARNING FOR ELECTRONIC DATA INTERCHANGE AND TEXT

(71) Applicant: INTERNATIONAL BUSINESS MACHINES CORPORATION, Armonk, NY (US)

(72) Inventors: Sthanikam Santhosh Kumar, Punganuru (IN); Manish Kumar Dash, Khallikote (IN); Pranav Seetharaman, Chennai (IN); Supriya Devidutta, Bhubaneswar (IN)

(21) Appl. No.: 18/329,904

(22) Filed: Jun. 6, 2023

(51) Int. Cl. G06N 20/00

(52) U.S. Cl. CPC G06N 20/00

(57) ABSTRACT

Multi-modal representation learning for electronic data interchange (EDI) and text includes encoding a text sample with a text encoder. The encoding creates an embedded text sample in a conjoined embedding space. An EDI sample is encoded with a multi-model EDI encoder. Encoding the EDI sample creates an embedded EDI sample in the conjoined embedding space. The multi-model EDI encoder includes a plurality of expert networks. The multi-modal EDI encoder is trained using machine learning to determine a similarity score between a target text and an EDI segment. The machine learning includes comparing labeled training samples and corresponding predictions generated by the multi-model EDI encoder. Once trained, the multi-model EDI encoder is configured to query a data repository of EDI documents for one or more selected EDI documents that match a natural language text input.

### BACKGROUND

This disclosure relates to intercomputer communications, and more particularly, to the exchange of electronic data between multiple computer systems.

A large portion of intercomputer communications involves the exchange of electronic data among different computer systems. Electronic data interchange (EDI) is a widely used mode of data exchange. EDI typically involves exchanges of data segments, or strings of data elements, often framed by a header and trailer forming a transaction set. EDI enables the exchange of data over the Internet, through serial links and peer-to-peer networks, and via various other data communication networks. EDI is often an essential aspect of B2B processes and for many entities is the preferred mode of transmitting and receiving data such as documents and forms.

### SUMMARY

In one or more embodiments, a method includes encoding a text sample with a text encoder. The encoding creates an embedded text sample in a conjoined embedding space. The method includes encoding an electronic data interchange (EDI) sample with a multi-model EDI encoder. Encoding the EDI sample creates an embedded EDI sample in the conjoined embedding space, and wherein the multi-model EDI encoder includes a plurality of expert networks. The method includes training the multi-modal EDI encoder to determine a similarity score between a target text and an EDI segment, wherein the multi-modal EDI encoder is trained by machine learning based on comparing labeled training samples and corresponding predictions generated by the multi-model EDI encoder. The method includes outputting the multi-model EDI encoder configured to query a data repository of EDI documents for one or more selected EDI documents that match a natural language text input.

The foregoing and other implementations can each optionally include one or more of the following features, alone or in combination. Some example embodiments include all the following features in combination.

In one aspect, an EDI type of the EDI sample is determined, and based on the type, the EDI sample is routed to one of the plurality of expert networks based on the EDI type. The routing may be performed by a router layer of the multi-model EDI encoder. The router layer is configured to route an EDI segment to one of the plurality of expert networks in response to determining the type of the EDI segment.

In another aspect, the multi-model EDI encoder includes a self-attention layer configured to weight each element of the EDI segment based on a context of each element.

In another aspect, the machine learning-based training includes iteratively adjusting parameters of the multi-modal EDI encoder based on a cross-entropy between the labeled training samples and corresponding predictions generated by the multi-model EDI encoder.

In another aspect, a target text can be input to the multi-model EDI encoder and one or more EDI segments embedded in the embedding space can be determined in response to the multi-model EDI encoder's determining a match between the target text and one or more EDI segments.

In another aspect, a plurality of new EDI segments can be input to the multi-model EDI encoder. One or more clusters of EDI segments can be generated based on determining similarities between pairs of the new EDI segments.

In one or more embodiments, a system includes one or more processors configured to initiate executable operations as described within this disclosure.

In one or more embodiments, a computer program product includes one or more computer-readable storage media and program instructions collectively stored on the one or more computer-readable storage media. The program instructions are executable by a processor to cause the processor to initiate operations as described within this disclosure.

This Summary section is provided merely to introduce certain concepts and not to identify any key or essential features of the claimed subject matter. Other features of the inventive arrangements will be apparent from the accompanying drawings and from the following detailed description.

### BRIEF DESCRIPTION OF THE DRAWINGS

FIG. 1 illustrates an example of a computing environment that is capable of implementing an EDI encoder model (EDIEM) framework 200.

FIG. 2 illustrates an example architecture of executable EDIEM framework of FIG. 1.

FIG. 3 illustrates an example method of operation of the EDIEM framework of FIGS. 1 and 2.

FIG. 4 illustrates an example multi-model EDI encoder implemented with the executable EDIEM framework of FIG. 1.

### DETAILED DESCRIPTION

While the disclosure concludes with claims defining novel features, it is believed that the various features described within this disclosure will be better understood from consideration of the description in conjunction with the drawings. The process(es), machine(s), manufacture(s) and any variations thereof described herein are provided for purposes of illustration. Specific structural and functional details described within this disclosure are not to be interpreted as limiting, but merely as a basis for the claims and as a representative basis for teaching one skilled in the art to variously employ the features described in virtually any appropriately detailed structure. Further, the terms and phrases used within this disclosure are not intended to be limiting, but rather to provide an understandable description of the features described.

This disclosure relates to intercomputer communications, and more particularly, to the exchange of electronic data between multiple computer systems. The receiver of an EDI file may use a different standard or different version of the same standard than that of the sender. Even if the sender and receiver use the same EDI standard the underlying document interchanged contains a considerable amount of exchange-related information that tends to obscure the substantive content. Thus, regardless of the specific format, the data structures that facilitate the interchange of EDI files make difficult a natural language understanding of the content. This is more than a mere annoyance. It precludes or impedes computer-based processing of the file. For example, the particular EDI formatting used for an interchange makes it difficult to perform machine-implemented data queries using natural language text. Machine-implemented retrieval of specified information across different types of EDI data, for example, is impeded. Machine learning techniques, such as cluster analysis, are likewise impeded.

In accordance with the inventive arrangements disclosed herein, methods, systems, and computer program products are provided that are capable of independently embedding EDI data and text in a common embedding space. In certain embodiments, the inventive arrangements implement a transformer-based encoder network for embedding text in the common embedding space. A novel model architecture is utilized to encode EDI data in the same, common embedding space, irrespective of the specific format of the data. The novel model architecture is a machine learning architecture comprising multiple neural networks, each including a plurality of distinct layers. Each of the multiple neural networks is referred to herein as an expert network. Utilizing the plurality of expert networks, the machine learning model learns the syntax and semantics of multiple, distinct EDI formats.

Additionally, the novel model architecture includes a routing linear layer, which takes an EDI data's format as a parameter (determined automatically or user specified) and, in accordance with the parameter, routes the corresponding EDI data to the respective expert network. In this way using a plurality of expert networks embeddings for all EDI formats can be generated using a single model. Thus, a single model is capable of generating common embeddings for EDI data drawn from multiple different EDI formats.

The single model is a multi-modality machine learning model that, once trained, encodes in the common embedding space both text and EDI data. The multi-modality machine learning model encodes EDI data comprising similar informational content with similar embeddings. The similarity is determined based on how similar the EDI data, regardless of EDI format, to a common text-based input. The more similar the content of EDI documents the closer the encoding of the EDI documents within the embedding space. Training the machine learning model includes training the two independent encoders—one for text and one for EDI data—in parallel with each other so that the model learns to encode text and EDI data comprising similar informational content with similar embeddings.

One aspect of the inventive arrangements is the automatic, machine-generated common embedding space for multiple EDI layouts by the multi-modality machine learning model. The inventive arrangements obviate the need for manual creation of such an embedding, which is a very tedious, error-prone task given the considerable array of different types of EDI formats.

Another aspect of the inventive arrangements is enabling a user to understand information conveyed via one modality (text or EDI data) by learning the content of data represented through another modality.

Apart from enhanced understanding, the inventive arrangements enable performance of certain machine-based operations not readily performed on EDI documents. In one aspect, once trained, the multi-modality machine learning model may query EDI data using text and vice versa. For example, for a plurality of EDI documents, such as order forms, some may reference a brand X product, and some may reference a brand Y product. The trained multi-modality machine learning model can identify which of the individual documents reference brand X and which brand Y in response to a text-based query. In contrast to Boolean-based searching, however, the inventive arrangements disclosed herein do not merely match a keyword (e.g., “Company A”) and list each document that contains the keyword. Rather, the inventive arrangements incorporate one or more machine learning models to determine the context of the keyword and, based on context, infer a user's intent. The machine learning model may be a transformer-based text encoder having an attention mechanism that determines context based on all words contained in an input. Using the machine learning model, for example, the user may wish to identify all EDI documents received from Company A. A Boolean search of a collection of EDI documents would determine a match and list all documents that mention Company A. This result would include documents sent to Company A and documents received from Company A so long as such documents included “Company A.” The search is devoid of any context and/or user intent other than the keyword. The inventive arrangements, by contrast, identify documents based on the context, that is, the document having been received, the received document having been received from Company A.

A user request for “all documents from Company A” using the Boolean search of the collection of EDI documents will perform an English-word lookup of all the EDI documents. There are, however, likely many EDI formats in which the sender information is encoded cryptically as, for example, ISA segments in X12, UNG in EDIFACT, or other encoding according to another EDI format, thereby obscuring the “from” context. Thus, while the Boolean search can identify all documents with the keyword “Company A,” the search does not discriminate, for example, between whether the document was sent from, sent to, or merely mentions company A. The Boolean search yields too many documents, only some which may be from Company A.

The inventive arrangements, by contrast, provide a common embedding space for text and EDI documents so that cryptic EDI segments can be matched based on context, which links a natural language word such “from” with an EDI-formatted term such as “sender id.” Accordingly, for a query like “retrieve all documents from Company A,” the inventive arrangements interpret the natural language word “from” as equivalent with, or corresponding to, the EDI-formatted “sending id” given that both terms—“from” and “sending id”—are within the common embedding space and are contextually linked by the machine intelligence of the inventive arrangements. The machine intelligence and context awareness of the inventive arrangements thus provide a more refined and more accurate solution than does the Boolean search.

Moreover, the inventive arrangements facilitate a search, as described herein, across a plurality of different EDI documents having different formats. The inventive arrangements, learn the syntax and semantics of each of the different EDI formats, which facilitates searching a collection of differently formatted EDI documents within a common embedding space.

Yet another aspect of the inventive arrangements is faster retrieval of EDI documents, when the documents are structured according to different EDI formats. The multi-modality machine learning model may search the documents encoded in the common embedding space to identify those EDI documents containing information that matches a text-based input.

Still another aspect of the inventive arrangements is the ability to perform cluster analysis of differently formatted EDI data. The multi-modality machine learning model may cluster similar EDI data together based on identifying data content that matches a text-based input.

Further aspects of the inventive arrangements are described below with reference to the figures. For purposes of simplicity and clarity of illustration, elements shown in the figures have not necessarily been drawn to scale. For example, the dimensions of some of the elements may be exaggerated relative to other elements for clarity. Further, where considered appropriate, reference numbers are repeated among the figures to indicate corresponding, analogous, or like features.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

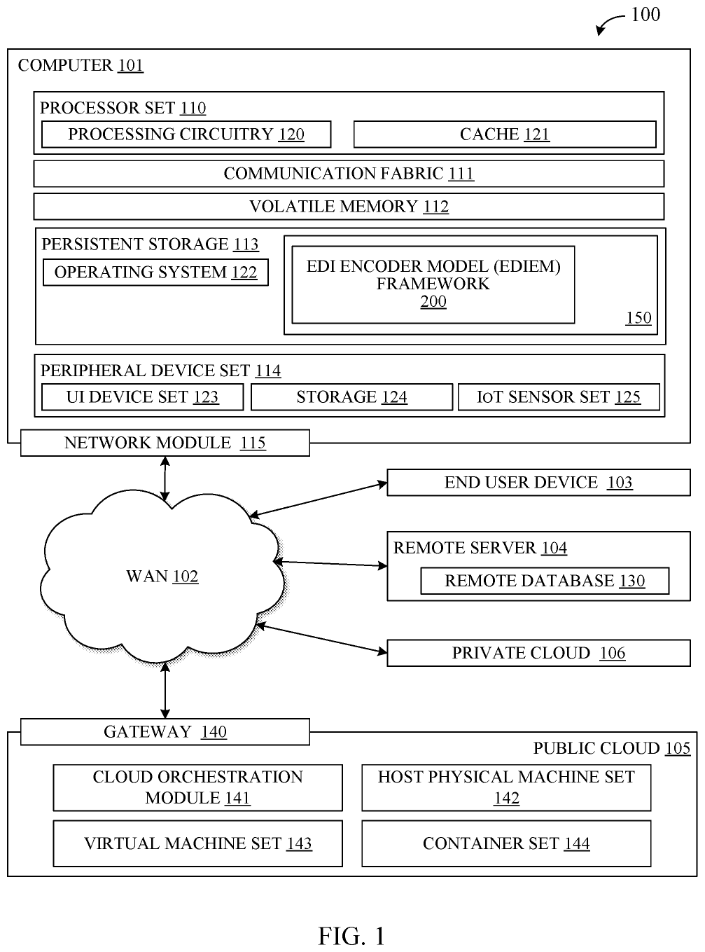

Referring to FIG. 1, computing environment 100 contains an example of an environment for the execution of at least some of the computer code in block 150 involved in performing the inventive methods, such as EDI encoder model (EDIEM) framework 200 implemented as executable program code or instructions. EDIEM framework 200 implements a multi-modality machine learning model that generates a joint embedding for both text and EDI data. Encoding the text and EDI data in the same embedding space facilitates using information from one modality for transforming, recognizing, clustering, and searching data represented through another modality. The multi-modality machine learning model implemented by EDIEM framework 200 for creating joint embeddings utilizes two independent encoders for text and EDI data. For text, EDIEM framework 200 may implement a transformer-based encoder network. For EDI data, EDIEM framework 200 implements an EDI encoder, a novel machine learning architecture comprising a plurality of expert networks, each comprising multiple layers and uniquely trained handle one of a plurality of different types of EDI formats. Each expert network learns the syntax and semantics of a specific one of the different EDI formats. The novel architecture is much more effective than a traditional stacked linear layer architecture. The EDI encoder also comprises a routing linear layer. The routing layer takes the EDI format as a parameter and routes EDI data to the respective expert network according to the parameter. In this way, EDIEM framework 200, using a plurality of expert networks, generates embeddings for all EDI formats using the single, multi-modal machine learning model.

Computing environment 100 additionally includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and ABC/ML EDIEM framework 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

Computer 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

Processor set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 150 in persistent storage 113.

Communication fabric 111 is the signal conduction paths that allow the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid-state storage devices. Operating system 122 may take several forms, such as various known proprietary operating systems or open-source Portable Operating System Interface type operating systems that employ a kernel. The code included in block 150 typically includes at least some of the computer code involved in performing the inventive methods.

Peripheral device set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (e.g., secure digital (SD) card), connections made though local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (e.g., where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (e.g., embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (e.g., the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 103 is any computer system that is used and controlled by an end user (e.g., a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (e.g., private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

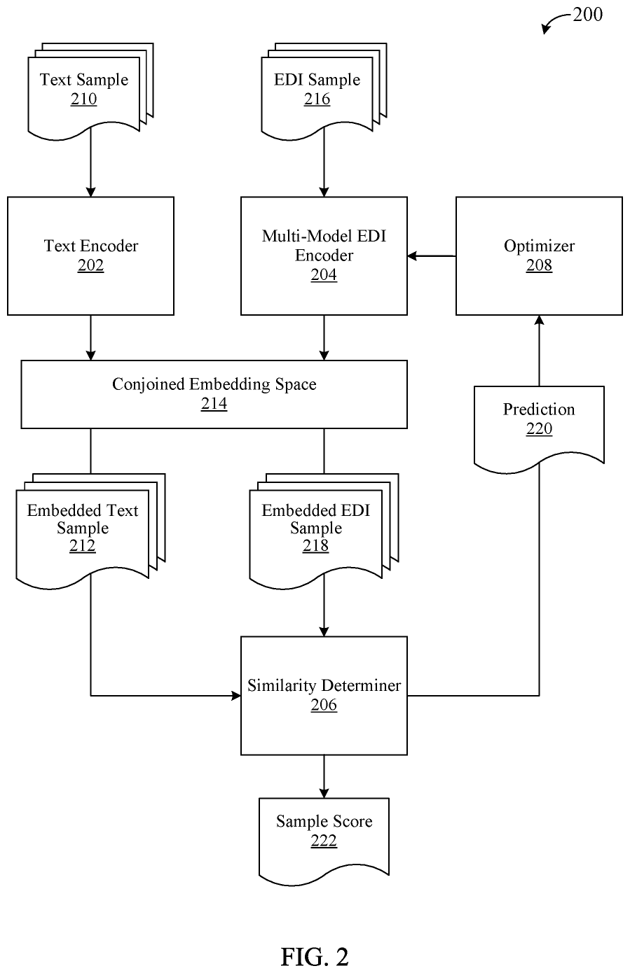

FIG. 2 illustrates an example architecture for the executable EDIEM framework 200 of FIG. 1. In the example of FIG. 2, EDIEM framework 200 illustratively includes text encoder 202, multi-model EDI encoder 204, similarity determiner 206, and optimizer 208.

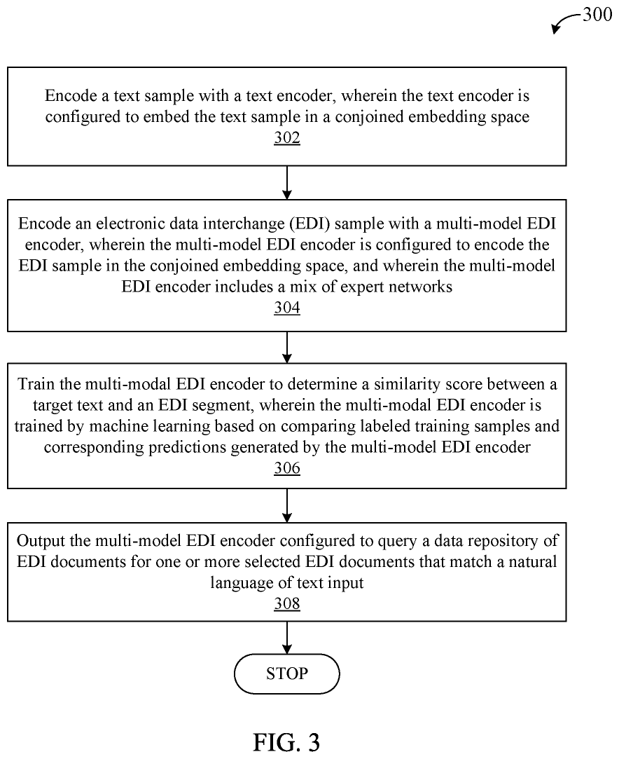

FIG. 3 illustrates an example method 300 of operation of the EDIEM framework 200 of FIGS. 1 and 2.

Referring to FIGS. 2 and 3 collectively, in block 302, text encoder 202 encodes text sample 210. Text sample 210 may be a document, sentence, phrase, or word expressed in natural language (e.g., English). The encoding performed by text encoder 202 creates embedded text sample 212 embedded in conjoined embedding space 214. Embedded text sample 212 is a numerical data structure representing text sample 210. In certain embodiments, embedded text sample 212 is an n-dimensional vector within conjoined embedding space 214, which is an n-dimensional vector space.

In certain embodiments, text encoder 202 is a transformer-based encoder, a deep learning model that incorporates self-attention. For example, text encoder 202, in some embodiments, is implemented as a Bidirectional Encoder Representations from Transformers (BERT) natural language processing (NLP) model.

In block 304, multi-model EDI encoder 204 encodes EDI sample 216. EDI sample 216 comprises EDI data formatted in any of a variable number of different EDI formats (e.g., X12, EDIFACT, XML). Thus, using any of the different EDI formats, EDI sample 216 can include information comparable to the natural language of text sample 210, albeit in a specific EDI format. Multi-model EDI encoder 204 creates embedded EDI sample 218. Embedded EDI sample 218 is embedded in the same embedding space as embedded sample text 212, namely conjoined embedding space 214. Thus, embedded text sample 212 and embedded EDI sample 218 are both embedded in a shared or conjoined vector space, conjoined embedding space 214. As with embedded text sample 212, embedded EDI sample 218 is an n-dimensional vector within conjoined embedding space 214, an n-dimensional vector space. Embedding both embedded text sample 212 and embedded EDI sample 218 in a shared or conjoined vector space facilitates certain operations performed by EDIEM framework 200, described in greater detail below.

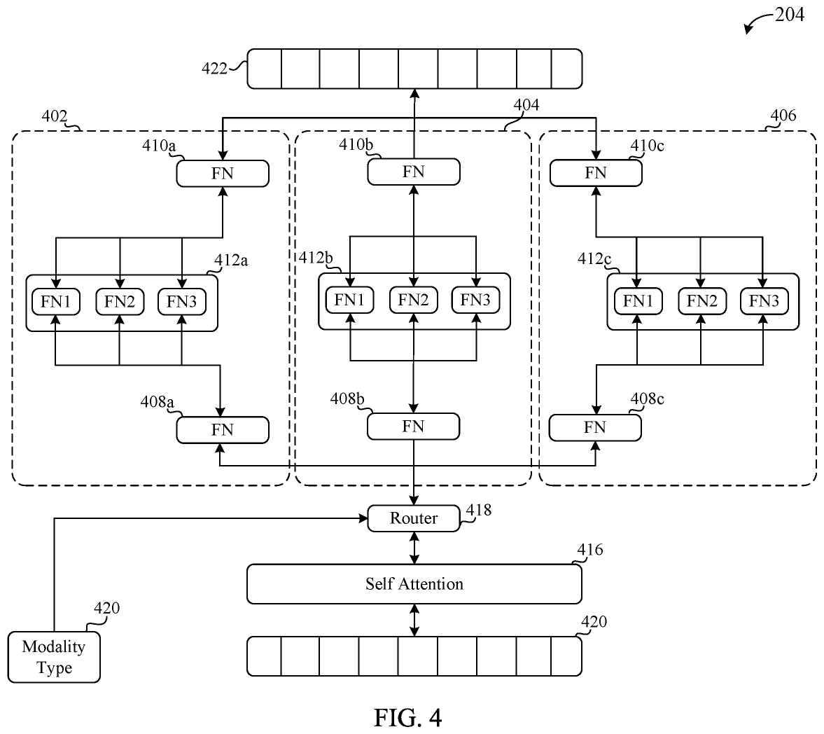

The architecture of multi-model EDI encoder 204 enables the handling of EDI samples that are formatted differently according to different EDI formats. FIG. 4 illustrates an example embodiment of multi-model EDI encoder 204. Illustratively, the example architecture of multi-model DEI encoder 204 is capable of handling EDI samples formatted in any one of three different EDI formats, using three distinct expert networks 402, 404, and 406. Expert networks 402, 404, and 406 are each a deep learning neural network. In certain embodiments of multi-model EDI encoder 204, each expert network 402, 404, and 406 comprises three parallel stacks of linear layers.

Expert networks 402, 404, 406 each comprises an input layer (layers 408a, 408b, 408c, respectively), an output layer (layers 410a, 410b, 410c, respectively) and a hidden layer (layers 412a, 412b, 412c, respectfully). Each layer is a fully connected network (FN) layer. Hidden layers 412a, 412b, and 412c each comprise three horizontal layers FN1, FN2, FN3. Whereas with vertical stacking, information is passed from one layer to another so that each layer learns aggregated information, the horizontal layers FN1, FN2, FN3 simultaneously receive information fed to each layer. Each of the horizontal layers FN1, FN2, FN3 may operate in parallel. Accordingly, the horizontal arrangement of the FN1, FN2, FN3 layers enables each of the layers to learn different aspects of the information. The learning of different aspects of the information may be performed by the horizontal layers FN1, FN2, FN3 in parallel with one another.

Illustratively, each of the three expert networks 402, 404, 406 (in other embodiments, a different number of expert networks may be used) has three fully connected horizontal layers (again, in other embodiments, a different number may be used). Each expert network is associated with a distinct EDI format. The fully connected horizontal layers of each expert network learn distinct aspects from the same feature data fed simultaneously to each.

Each expert network 402, 404, and 406 is trained through supervised machine learning to learn the syntax and semantics of data formatted in a distinct EDI format. Through supervised machine learning, each expert network 402, 404, and 406 learns the structure of various EDI formats such as X12, EDIFACT, cXML, etc. The learning process also assists each expert network 402, 404, and 406 in recognizing the hierarchy of tags and properties within different segments and elements of each standard. Once trained, each expert network 402, 404, and 406 is capable of understanding both the syntax and semantics of the data structured according to a specific EDI format.

In addition to expert networks 402, 404, and 406, multi-model EDI encoder 204 includes self-attention layer 416 and router 418. Operatively, input 414 to multi-model EDI encoder 204 is fed into self-attention layer 416. Input 414 may be an EDI segment. Self-attention layer 416 may itself include three fully connected query, key, and value layers for implementing an attention mechanism. The attention mechanism weights elements (e.g., words) of EDI segments. As used herein, “EDI segment” means a document, one or more sentences, phrase, or word formatted in an EDI format. Self-attention layer 416 weights an element of an EDI segment by performing a parallel determination of the element's context with respect to all elements (e.g., other words) in the EDI segment. In some embodiments, self-attention layer 416 is implemented as a pre-trained distillBERT model. Self-attention layer 416 weights each element of an EDI segment based on a context of the EDI segment; each weight corresponds to the relative importance of the weighted element with respect to each other element.

Having passed through self-attention layer 416, input 414 is routed to one of expert networks 402, 404, and 406 by router 418, which is also part of multi-model EDI encoder 204. Self-attention layer 416 encodes input 414, embedding input 414 as encoded input in conjoined embedding space 214, which is jointly shared with text encoded by text encoder 202. Router 418 may select which expert network 402, 404, or 406 to route input 414 to by determining modality type 420 corresponding to input 414. Modality type 420 may be a parameter that indicates the EDI format of input 414. The parameter may be supplied by user input or determined by router 418 automatically from the specific data structure of input 414 itself. In either event, multi-model EDI encoder 204, having been trained, determines representation 422 from input 414. As described in greater detail below, a representation, such as representation 422 can be compared with a target text to determine whether the information of the EDI segment (input 414) is similar to (and to what degree) the natural language of a text, such as text sample 210, once multi-model EDI encoder 204 is trained. The bidirectionality of the arrows in FIG. 4 indicates data flow and processing, forward arrows corresponding to feedforward processing and the backward arrows indicating backpropagation during training using machine learning.

Referring still to FIG. 3, in block 306, multi-model EDI encoder 204 is trained using machine learning to determine a similarity score between a target text and an EDI segment. The machine learning is based on comparing labeled training samples and corresponding predictions generated by multi-model EDI encoder 204. Encoding text samples and EDI samples in conjoined embedding space 214, yields embedded samples that are numerical representations of both the text and EDI samples as n-dimensional vectors. Similarity determiner 206 utilizes the fact that embeddings of both text and EDI samples are in the same vector space (conjoined embedding space 214) to compute the inner (or dot) product of the samples' respective n-dimensional vector representations to determine similarity scores between sample pair. The closer the vector representations are to one another in conjoined embedding space 214, the greater the inner product computed. Therefore, the similarity in the natural language of a text sample and EDI sample is quantitatively measurable by the inner product computed by similarity determiner 206. Text and EDI sample are similar if the value of the inner product of their vector representations is greater than a predetermined maximum.

Thus, text sample 210 and EDI sample 216, respectively, are fed to two independent encoders, text encoder 202 and multi-model EDI encoder 204, which generate the respective embeddings (embedded text sample 212 and embedded EDI sample 218) within conjoined embedding space 214. Based on the dot product of embedded text sample 212 and embedded EDI sample 218, the similarity between the respective embeddings is determined by similarity determiner 206. If text sample 210 and EDI sample 216 represent the same or sufficiently similar information, the dot product is greater than the predetermined maximum.

Multi-model EDI encoder 204 may be trained by machine learning based on comparing labeled training samples and corresponding predictions generated by the multi-model EDI encoder. Training may be performed in batches, in which each batch comprises a mini-batch of K pairs of text and EDI sample pairs. If the text and EDI samples match the sample pair is labeled as similar by similarity determiner 206. A match is determined based on whether the inner product corresponding to the pair is greater than the predetermined maximum. In training multi-model EDI encoder 204, prediction 220 is generated by multi-model EDI encoder 204 for a training sample (text and EDI sample pair). Based on prediction 220, multi-model EDI encoder 204 assigns a corresponding label (e.g., one if match or otherwise zero) to the training sample. During training, therefore, each text and EDI sample pair is collected from the training dataset. Text and EDI data are fed, respectively, into text encoder 202 and multi-model EDI encoder 204. The embedded output from text encoder 202 and multi-model EDI encoder 204 are compared by similarity determiner 206 to generate the label indicating whether the pair comprises the same or similar data.

The label based on the prediction is fed to optimizer 208. Optimizer 208 compares the label based on prediction 220 with a correct, predetermined label of the training sample to determine the accuracy of the prediction. Optimizer 208 can iteratively adjust the parameters of expert networks 402, 404, and 406 of multi-model EDI encoder 204 until predictions generated by multi-model EDI encoder 204 achieve a predetermined level of accuracy (e.g., greater than 85 percent or higher).

In some embodiments, optimizer 208 includes an objective (or cost) function and seeks to optimize the predictive accuracy of multi-model EDI encoder by minimizing the cost occurred from making incorrect predictions and adjusting the parameters of expert networks 402, 404, and 406 commensurate with the magnitude of the cost. In some embodiments, optimizer 208 determines the cost by computing a cross-entropy (e.g., binary cross-entropy) for each of the predictions. The training thus iteratively adjusts parameters of multi-modal EDI encoder 204 by making adjustments that reduce the cross-entropy between the labeled training samples and corresponding predictions generated by multi-model EDI encoder 204.

In block 308, the now-trained implementation of multi-model EDI encoder 204 is output by EDIEM framework 200. As output, multi-model EDI encoder 204 is configured to query a data repository of EDI documents for one or more selected EDI documents that match a natural language text input. Having been trained, multi-model EDI encoder 204 is capable of determining similarity score 222, which quantitatively indicates the closeness of EDI sample 216 to the natural language of text sample 210. Multi-model EDI encoder 204's ability to determine the similarity between an EDI segment (e.g., document, form, sentence, word) and a text input can be applied to performing a considerable number of operations.

Among the operations performable by EDIEM framework 200 once trained is inputting a target text to the multi-model EDI encoder and searching a database or other collection of EDI documents to determine which EDI documents contain information identical to, or similar with, the target text. For example, the collection of EDI documents may be order forms, some of which refer to product A, others that refer to product B, and so forth. A text specifying a particular product can be input to text encoder 202 to be embedded as embedded text in conjoined embedding space 214. Multi-modal EDI encoder 204 determines similarity score for each EDI document based on the inner products computed by similarity determiner 206. Those EDI documents having greater-than-threshold score values are identified as referencing the particular product.

In addition to text-to-EDI searches, EDIEM framework 200 also facilitates EDI-to-EDI queries. For example, consider an X12-formated transaction containing details about the purchase of from a specific company (Company A). EDIEM framework 200 is capable of identifying similar transactions in other formats, such as EDIFACT, cXML, etc. EDI-to-EDI queries may be performed by EDIEM framework 200, in part, because all EDI data formatted according to different EDI formats share a common embedding space, such as conjoined embedding space 214 described with reference to FIG. 2. Like text-to-EDI comparisons, EDIEM framework 200 also performs EDI-to-EDI similarity checks using the operations described herein with respect to the common embedding space.

Another operation performable by EDIEM framework 200 once trained is clustering of similar EDI documents contained in a collection of EDI documents. A text input can provide a basis for clustering EDI documents by specifying certain information. EDIEM framework 200 can enable the specifying by a user of the degree to which EDI documents must be similar. The degree of similarity is set by the user specifying a threshold similarity score, the value of which is determined by the values of the inner product computed by similarity determiner 206. The similarity score determines whether an EDI document is sufficiently similar to the text. The inner product of the n-dimensional vector representations of each EDI document of the collection is computed with respect to that of the text. Each EDI document for which a corresponding value of the inner product exceeds the user-specified threshold is given a similarity score that leads to adding the EDI document a cluster. Clustering is complete similarity scores have been determined for each of the EDI documents within the collection.

The terminology used herein is for the purpose of describing particular embodiments only and is not intended to be limiting. Notwithstanding, several definitions that apply throughout this document will now be presented.

As defined herein, the term “approximately” means nearly correct or exact, close in value or amount but not precise. For example, the term “approximately” may mean that the recited characteristic, parameter, or value is within a predetermined amount of the exact characteristic, parameter, or value.

As defined herein, the terms “at least one,” “one or more,” and “and/or,” are open-ended expressions that are both conjunctive and disjunctive in operation unless explicitly stated otherwise. For example, each of the expressions “at least one of A, B and C.” “at least one of A, B, or C,” “one or more of A, B, and C.” “one or more of A, B, or C.” and “A, B, and/or C” means A alone, B alone, C alone, A and B together, A and C together, B and C together, or A, B and C together.

As defined herein, the term “automatically” means without user intervention.

As defined herein, the terms “includes,” “including.” “comprises,” and/or “comprising.” specify the presence of stated features, integers, steps, operations, elements, and/or components, but do not preclude the presence or addition of one or more other features, integers, steps, operations, elements, components, and/or groups thereof.

As defined herein, the term “if” means “when” or “upon” or “in response to” or “responsive to,” depending upon the context. Thus, the phrase “if it is determined” or “if [a stated condition or event] is detected” may be construed to mean “upon determining” or “in response to determining” or “upon detecting [the stated condition or event]” or “in response to detecting [the stated condition or event]” or “responsive to detecting [the stated condition or event]” depending on the context.

As defined herein, the terms “one embodiment,” “an embodiment,” “in one or more embodiments,” “in particular embodiments,” or similar language mean that a particular feature, structure, or characteristic described in connection with the embodiment is included in at least one embodiment described within this disclosure. Thus, appearances of the aforementioned phrases and/or similar language throughout this disclosure may, but do not necessarily, all refer to the same embodiment.

As defined herein, the term “output” means storing in physical memory elements, e.g., devices, writing to display or other peripheral output device, sending or transmitting to another system, exporting, or the like.

As defined herein, the term “processor” means at least one hardware circuit configured to carry out instructions. The instructions may be contained in program code. The hardware circuit may be an integrated circuit. Examples of a processor include, but are not limited to, a central processing unit (CPU), an array processor, a vector processor, a digital signal processor (DSP), a field-programmable gate array (FPGA), a programmable logic array (PLA), an application specific integrated circuit (ASIC), programmable logic circuitry, and a controller.

As defined herein, “real time” means a level of processing responsiveness that a user or system senses as sufficiently immediate for a particular process or determination to be made, or that enables the processor to keep up with some external process.

As defined herein, the term “responsive to” means responding or reacting readily to an action or event. Thus, if a second action is performed “responsive to” a first action, there is a causal relationship between an occurrence of the first action and an occurrence of the second action. The term “responsive to” indicates the causal relationship.

As defined herein, the term “substantially” means that the recited characteristic, parameter, or value need not be achieved exactly, but that deviations or variations, including for example, tolerances, measurement error, measurement accuracy limitations, and other factors known to those of skill in the art, may occur in amounts that do not preclude the effect the characteristic was intended to provide.

As defined herein, the term “user” refers to a human being.

The terms “first,” “second,” etc. may be used herein to describe various elements. These elements should not be limited by these terms, as these terms are only used to distinguish one element from another unless stated otherwise or the context clearly indicates otherwise.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method, comprising:
encoding a text sample with a text encoder, wherein the encoding creates an embedded text sample in a conjoined embedding space;
encoding an electronic data interchange (EDI) sample with a multi-model EDI encoder, wherein the encoding the EDI sample creates an embedded EDI sample in the conjoined embedding space, and wherein the multi-model EDI encoder includes a plurality of expert networks;
training the multi-modal EDI encoder to determine a similarity score between a target text and an EDI segment, wherein the multi-modal EDI encoder is trained by machine learning based on comparing labeled training samples and corresponding predictions generated by the multi-model EDI encoder; and
outputting the multi-model EDI encoder configured to query a data repository of EDI documents for one or more selected EDI documents that match a natural language text input.

2. The method of claim 1, further comprising:
determining an EDI type of the EDI sample; and
routing the EDI sample to one of the plurality of expert networks based on the EDI type.

3. The method of claim 2, wherein the routing is performed by a router layer of the multi-model EDI encoder, wherein the router layer is configured to route an EDI segment to one of the plurality of expert networks in response to the determining the type of the EDI segment.

4. The method of claim 1, wherein the multi-model EDI encoder includes a self-attention layer configured to weight each element of the EDI segment based on a context, the weight corresponding to the relative importance of each element with respect to each other element.

5. The method of claim 1, wherein the training includes iteratively adjusting parameters of the multi-modal EDI encoder based on a cross-entropy between the labeled training samples and corresponding predictions generated by the multi-model EDI encoder.

6. The method of claim 1, further comprising:
inputting a target text to the multi-model EDI encoder; and
identifying one or more EDI segments embedded in the embedding space in response to the multi-model EDI encoder's determining a match between the target text and one or more EDI segments.

7. The method of claim 1, further comprising:
inputting a plurality of new EDI segments to the multi-model EDI encoder; and
generating by the multi-model EDI encoder one or more clusters based on determining similarities between pairs of the new EDI segments.

8. The method of claim 1, wherein the text encoder is a transformer-based encoder.

9. A system, comprising:
one or more processors configured to initiate operations including:
encoding a text sample with a text encoder, wherein the encoding creates an embedded text sample in a conjoined embedding space;
encoding an electronic data interchange (EDI) sample with a multi-model EDI encoder, wherein the encoding the EDI sample creates an embedded EDI sample in the conjoined embedding space, and wherein the multi-model EDI encoder includes a plurality of expert networks;
training the multi-modal EDI encoder to determine a similarity score between a target text and an EDI segment, wherein the multi-modal EDI encoder is trained by machine learning based on comparing labeled training samples and corresponding predictions generated by the multi-model EDI encoder; and
outputting the multi-model EDI encoder configured to query a data repository of EDI documents for one or more selected EDI documents that match a natural language text input.

10. The system of claim 9, wherein the one or more processors are configured to initiate operations further including:
determining an EDI type of the EDI sample; and
routing the EDI sample to one of the plurality of expert networks based on the EDI type.

11. The system of claim 9, wherein the training includes computing a cross-entropy based on the prediction generated by the multi-model EDI encoder for each of the plurality of EDI segments.

12. The system of claim 9, wherein the one or more processors are configured to initiate operations further including:
inputting a target text to the multi-model EDI encoder; and
identifying one or more EDI segments embedded in the embedding space in response to the multi-model EDI encoder's determining a match between the target text and one or more EDI segments.

13. The system of claim 9, wherein the one or more processors are configured to initiate operations further including:
inputting a plurality of new EDI segments to the multi-model EDI encoder; and
generating by the multi-model EDI encoder one or more clusters based on determining similarities between pairs of the new EDI segments.

14. A computer program product, the computer program product comprising:
one or more computer-readable storage media and program instructions collectively stored on the one or more computer-readable storage media, the program instructions executable by a processor to cause the processor to initiate operations including:
encoding a text sample with a text encoder, wherein the encoding creates an embedded text sample in a conjoined embedding space;
encoding an electronic data interchange (EDI) sample with a multi-model EDI encoder, wherein the encoding the EDI sample creates an embedded EDI sample in the conjoined embedding space, and wherein the multi-model EDI encoder includes a plurality of expert networks;
training the multi-modal EDI encoder to determine a similarity score between a target text and an EDI segment, wherein the multi-modal EDI encoder is trained by machine learning based on comparing labeled training samples and corresponding predictions generated by the multi-model EDI encoder; and
outputting the multi-model EDI encoder configured to query a data repository of EDI documents for one or more selected EDI documents that match a natural language text input.

15. The computer program product of claim 14, wherein the program instructions are executable by the processor to cause the processor to initiate operations further including:
determining an EDI type of the EDI sample; and
routing the EDI sample to one of the plurality of expert networks based on the EDI type.

16. The computer program product of claim 15, wherein the multi-model EDI encoder includes a router layer configured to route an EDI segment to one of the plurality of expert networks in response to the determining the type of the EDI segment.

17. The computer program product of claim 14, wherein the multi-model EDI encoder includes a self-attention layer configured to weight each element of the EDI segment based on a context, the weight corresponding to the relative importance of each element with respect to each other element

18. The computer program product of claim 14, wherein the training includes iteratively adjusting parameters of the multi-modal EDI encoder based on a cross-entropy between the labeled training samples and corresponding predictions generated by the multi-model EDI encoder.

19. The computer program product of claim 14, wherein the program instructions are executable by the processor to cause the processor to initiate operations further including:
inputting a target text to the multi-model EDI encoder; and
identifying one or more EDI segments embedded in the embedding space in response to the multi-model EDI encoder's determining a match between the target text and one or more EDI segments.

20. The computer program product of claim 14, wherein the program instructions are executable by the processor to cause the processor to initiate operations further including:
inputting a plurality of new EDI segments to the multi-model EDI encoder; and
generating by the multi-model EDI encoder one or more clusters based on determining similarities between pairs of the new EDI segments.
